(19) United States
(12) Patent Application Publication
(10) Pub. No.: US 2025/0075869 A1
(43) Pub. Date: Mar. 6, 2025

(54) PROJECTION LENS FOR A HEADLIGHT OF A MOTOR VEHICLE AND HEADLAMP WITH SUCH A PROJECTION LENS

(71) Applicant: Hella GmbH & Co. KGaA, Lippstadt (DE)

(72) Inventors: Gerhard Kloos, Erwitte (DE); Benjamin Willeke, Paderborn (DE)

(21) Appl. No.: 18/817,749

(22) Filed: Aug. 28, 2024

(30) Foreign Application Priority Data
Sep. 1, 2023 (DE) 102023123570.2

(51) Int. Cl. F21S 41/265

(52) U.S. Cl. CPC F21S 41/265

(57) ABSTRACT

A projection lens has a substrate made of a transparent material, which has a light entry surface for the light exiting a primary optical element in a headlamp. A light emission surface is opposite the light entry surface. A Fresnel structure is formed on the substrate, which contains numerous coaxial annular steps, each of which has an emission surface and a diffractive surface. The emission surface is that part of the step through which light passes. The diffractive surface is that part of the step that is not configured for light to pass through it. At least one of the diffractive surfaces is curved.

### CROSS REFERENCE

This application claims priority to German Application No. 10 2023 123570.2, filed Sep. 1, 2023, the entirety of which is hereby incorporated by reference.

### FIELD OF THE INVENTION

The present invention relates to a projection lens for a headlamp in a motor vehicle, and a headlamp.

### BACKGROUND OF THE INVENTION

This type of projection lens is disclosed in DE 11 2013 007 443 B4. The projection lens described therein is configured to convert an expanded light distribution generated by a primary optical element in the headlamp to a light distribution corresponding to the output light distribution of the headlamp. The projection lens can comprise at least one substrate made of a transparent material, which has a Fresnel structure with numerous coaxial annular steps.

These Fresnel lenses are lighter and thinner than conventional lenses normally used in projections modules for headlamps. One idiosyncrasy with Fresnel lenses is that the annular steps each have a transmitting surface and a diffractive surface, in which the transmitting surface is that part of the step through which light is emitted, and the diffractive surface is that part of the step that is not configured for light to pass directly through it. The diffractive surfaces between the transmitting surfaces concentrate diffused light, thus resulting in blinding light exceeding the limit values for projection modules. The diffractive surfaces can also generate visible rings of diffused light, disrupting the homogeneity of the projected light.

### BRIEF SUMMARY OF THE INVENTION

The fundamental problem addressed by the invention is that of creating of a projection lens like that described above, in which the diffused light, and/or rings of diffused light, and/or the intensity of the diffused light is reduced. A headlamp of the above type is also to be obtained therewith.

At least one of the diffractive surfaces is curved. In particular, numerous, or all, of the diffractive surfaces can be curved. Curving at least one, preferably more or all, of the diffractive surfaces results in a distribution of the luminous flux in the diffused light over a greater area than with a planar surface. This reduces the overall diffusion of the light. It can also reduce the intensity of the diffused light in individual regions. In particular, rings of diffused light are eliminated.

One, more, or all of the diffractive surfaces can be concave. Alternatively, they can be convex. It is also the case that one, more, or all of the diffractive surfaces can have numerous curves, in particular such that some have a concave curvature and some have a convex curvature.

The shape and/or extent of curvature can be the same for numerous or all of the diffractive surfaces.

At least one of the diffractive surfaces can have a different curvature or curvature radius than at least one of the other diffractive surfaces. In this case, the curvature of one of the diffractive surfaces can have a shape and/or radius differing from the shape and/or radius of the other diffractive surfaces. By way of example, the inclinations of the main planes where the respective curvatures occur can be different in the different diffractive surfaces.

The shape and/or radius of the diffractive surfaces can change continuously toward the outside in the annular steps of the Fresnel structure.

Alternatively, the shape and/or radius of the diffractive surfaces does not change continuously toward the outside in the annular steps of the Fresnel structure. By way of example, the shape and/or radius of adjacent diffractive surfaces may differ to a greater extent than the shape and/or radius of diffractive surfaces that are not adjacent to one another.

The substrate on which the Fresnel structure is formed can be flat.

Alternatively, this substrate can be curved, such that it has a convex side and a concave side. With a curved substrate, the projection lens can be thinner than a conventional plano-convex lens, while still retaining the optical properties for which it is intended. This reduces the weight of the lens as well as the time and costs required for its production.

The Fresnel structure can be on the entry side of the substrate. It can also be on the emission side of the substrate.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic side view of a headlamp according to the invention.

FIG. 2 shows a schematic detail of a first embodiment of the projection lens according to the invention.

FIG. 3 shows a schematic detail of a second embodiment of the projection lens according to the invention.

FIG. 4 shows a schematic detail of a third embodiment of the projection lens according to the invention.

FIG. 5 shows a schematic detail of a fourth embodiment of the projection lens according to the invention.

FIG. 6 shows a schematic detail of a fifth embodiment of the projection lens according to the invention.

FIG. 7 shows a schematic detail of a sixth embodiment of the projection lens according to the invention.

FIG. 8 shows a schematic beam path through the projection lens shown in FIG. 7, in which beam paths of a projection lens with planar diffractive surfaces are also indicated.

### DETAILED DESCRIPTION OF THE DRAWINGS

Identical and functionally identical parts have the same reference symbols in the drawings.

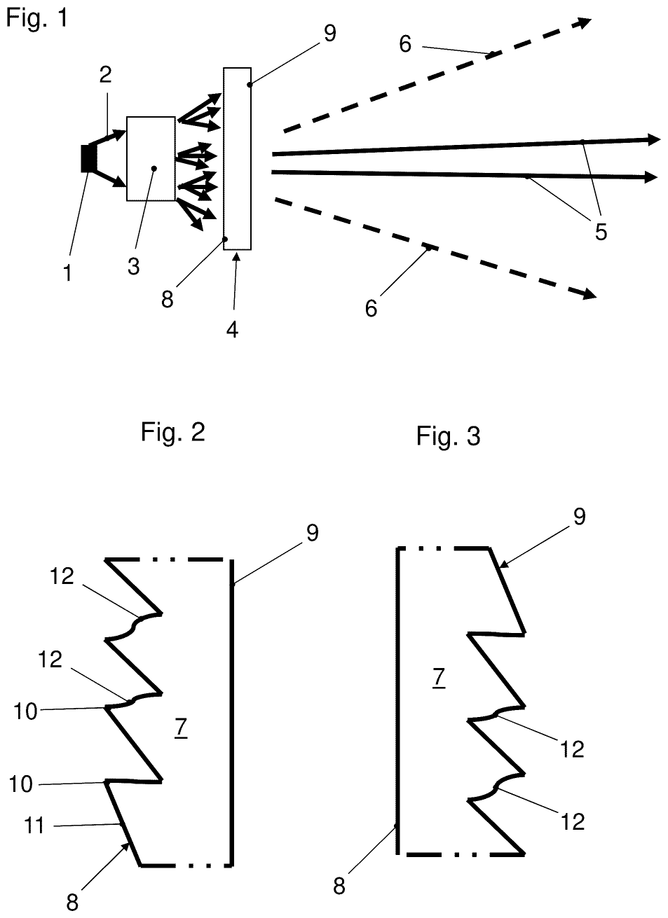

FIG. 1 shows a schematic illustration of an embodiment of a headlamp obtained with the invention. The light 2 emitted by at least one light source 1 in the headlamp is shaped by a primary optical element 3 such that an expanded light distribution is obtained downstream thereof. One or more blinds can be used to obtain the desired shape of the light distribution.

The headlamp also contains a projection lens 4. This projection lens 4 is the projection lens obtained with the invention, which shall be explained in greater detail below. FIG. 1 just shows a schematic illustration of the projection lens 4. The projection lens 4 is designed such that the expanded light distribution generated by the primary optical element 3 is converted to a light distribution corresponding to an output light distribution of the headlamp. This is indicated in FIG. 1 by the beam path of the light 5 passing through the projection lens 4 illustrated schematically by the solid lines.

The beam paths of the diffused light 6 exiting the projection lens 4 are schematically indicated in FIG. 1 by broken lines. This diffused light 6 can exit the diffraction surfaces of the projection lens, which shall be explained in greater detail below.

The projection lens 4 shown in greater detail in FIGS. 2 through 8 is made of plastic. The projection lens 4 has a substrate 7 with an entry surface 8 and emission surface 9 for the light exiting the primary optical element 3 (see FIGS. 1 and 2).

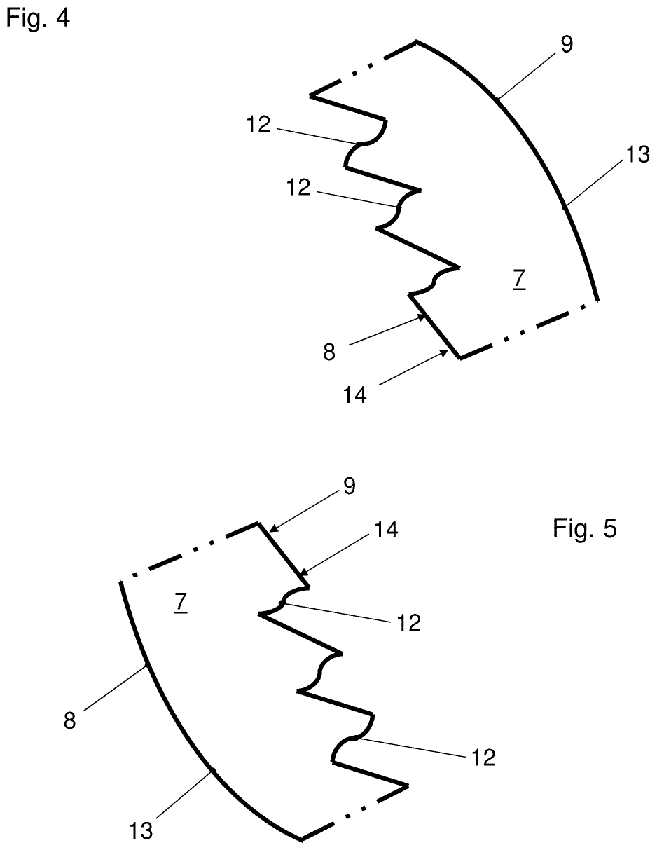

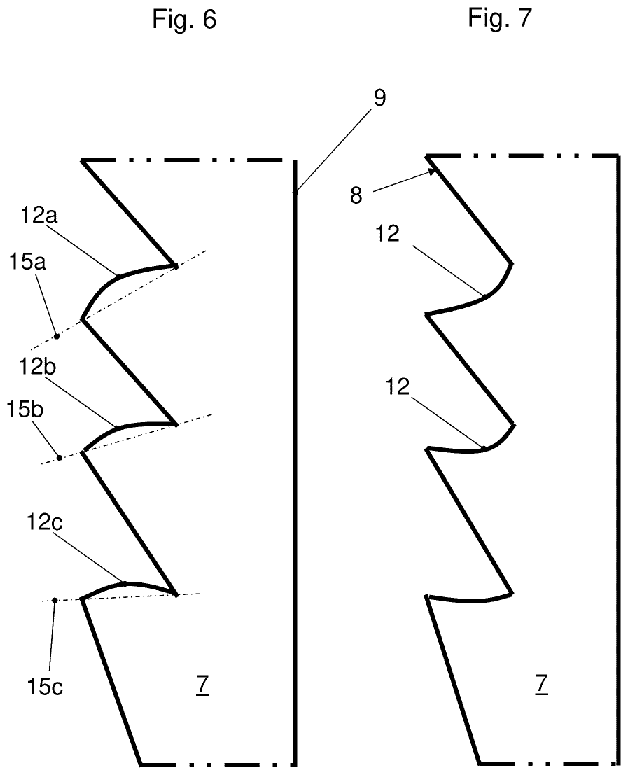

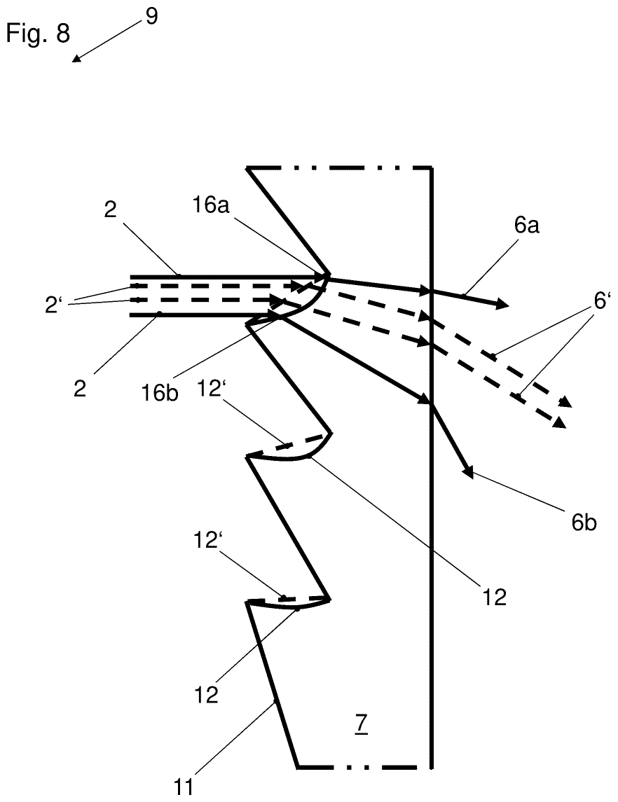

In the embodiments shown in FIG. 2, FIG. 3, FIG. 6 and FIG. 7, the substrate 7 is flat and made of a transparent material. The substrate in the embodiments shown in FIG. 4 and FIG. 5 is curved and made of a transparent material, resulting in a convex side 13 and a concave side 14. The curved substrate 7 follows the form of a hollow sphere or ellipsoid, in which the convex side 13 is the outer surface, and the concave side 14 corresponds to the inner surface of a hollow sphere or ellipsoid.

The concave side 14 can be the light entry side 8, and the convex side 13 can be the light emission side 9 of the projection lens (see FIG. 4). Alternatively, the convex side 13 can be the light entry side 8, and the concave side 14 can be the light emission side 9 of the projection lens (see FIG. 5).

The projection lens 4 also has a Fresnel structure, containing numerous annular steps 10, the axial direction of which coincides with the optical axis, such that the annular steps 10 are coaxial to one another and to the optical axis 3 of the projection lens 4. The Fresnel structure can be on the light entry side 8 (see FIG. 2, FIG. 4, FIG. 6, and FIG. 7) or on the light emission side 9 (see FIG. 3 and FIG. 5).

The annular steps 10 each have a light emission surface 11 and a diffractive surface 12 (see FIG. 2 by way of example). The emission surface 11 is that part of the step 10 through which light passes, while the diffractive surface 12 is that part of the step 10 that is not configured for light to pass through it.

The emission surfaces 11 are planar in the embodiments shown in the drawings, while at least some of the diffractive surfaces 12 are curved. The diffractive surfaces 12 can be concave (see FIG. 7). The diffractive surfaces 12 can also be convex (see FIG. 6). The diffractive surfaces 12 can also have numerous curves, some of which have a concave curvature, and some of which have a convex curvature (see FIGS. 2 through 5).

The shapes and/or radii of the curvatures of the diffractive surfaces 12 in different annular steps 10 differ from one another. The shapes and/or radii of some, or all, of the diffractive surfaces 12 can also be the same.

Furthermore, the inclinations of the main planes 15a, 15b, 15c in the embodiment shown in FIG. 6 (see the lines formed by alternating dashes and dots), in which the curvatures of the diffractive surfaces 12a, 12b, 12c are formed, differ from one another.

The shapes and/or radii of the curvatures in the diffractive surfaces 12 can change continuously in the different annular steps 10 toward the outside thereof. Alternatively, the shapes and/or radii of the curvatures of the diffractive surfaces 12 does not have to change continuously in the different annular steps 10 of the Fresnel structure.

FIG. 8 illustrates the effects of the curved diffractive surfaces 12 on the expansion of the diffused light 6 generated by the diffractive surfaces 12. The planar diffractive surfaces 12′ from the prior art are indicated with broken lines therein. All of the light 2′ striking these diffractive surfaces 12′ (see the arrows drawn with broken lines) is deflected by the diffractive surfaces 12′ as diffused light 6′ in the same direction.

In contrast, the light 2 (indicated by arrows drawn with solid lines) striking different sections 16a, 16b of the curved diffractive surfaces 12 is deflected by the diffractive surfaces 12 as diffused light 6a, 6b in different directions. This distributes the diffused light 6 over a greater area, such that the intensity of the diffused light 6 is reduced in the individual areas.

### LIST OF REFERENCE SYMBOLS

1 light source
2, 2′ light emitted from the light source
3 primary optical element
4 projection lens
5 light passing through the projection lens
6, 6a, 6b, 6′ diffused light
7 substrate
8 light entry surface of the substrate
9 light emission surface of the substrate
10 annular steps of the Fresnel structure
11 light emission surfaces of the annular steps
12, 12a, 12b, 12c, 12′ diffractive surfaces of the annular steps
13 convex side of the curved substrate
14 concave side of the curved substrate
15a, 15b, 15c main plane, in which the curvature of the diffractive surface located
16a, 16b sections of the diffractive surfaces

1. A projection lens for a headlamp in a motor vehicle, the projection lens configured to convert an expanded light distribution generated by a primary optical element in the headlamp into a light distribution corresponding to an output light distribution of the headlamp, the projection lens comprising:
a substrate made of a transparent material, which has a light entry surface for the light exiting the primary optical element in the headlamp, and a light emission surface opposite the light entry surface,
wherein a Fresnel structure is formed on the substrate, the Fresnel structure containing numerous coaxial annular steps, each of which has an emission surface and a diffractive surface,
wherein the emission surface is that part of the step through which light passes, and
wherein the diffractive surface is that part of the step that is not configured for light to pass through it,
wherein at least one of the diffractive surfaces is curved.

2. The projection lens according to claim 1, wherein a plurality of the diffractive surfaces are curved.

3. The projection lens according to claim 1, wherein at least one of the diffractive surfaces have a concave curvature.

4. The projection lens according to claim 1, wherein at least one of the diffractive surfaces have a convex curvature.

5. The projection lens according to claim 1, wherein at least one of the diffractive surfaces have numerous curvatures.

6. The projection lens according to claim 1, wherein a shape and/or radius of the curvature in a plurality of the diffractive surfaces is the same.

7. The projection lens according to claim 1, wherein a shape and/or radius of the curvature in at least one of the diffractive surfaces differs from the shape and/or radius of the curvature in at least one other diffractive surface.

8. The projection lens according to claim 7, wherein the curvature of one of the diffractive surfaces has a shape and/or radius that differs from the shape and/or radius of the curvature of the other diffractive surfaces.

9. The projection lens according to claim 7, wherein the curvature of one of the diffractive surfaces has a shape and/or radius that changes continuously in different annular steps of the Fresnel structure toward the outside.

10. The projection lens according to claim 7, wherein the curvature of one of the diffractive surfaces has a shape and/or radius that does not change continuously in different annular steps of the Fresnel structure toward the outside.

11. The projection lens according to claim 1, wherein the substrate on which the Fresnel structure is formed is a flat, uncurved substrate.

12. The projection lens according to claim 1, wherein the substrate on which the Fresnel structure is formed is curved substrate, which has a convex side and a concave side opposite the convex side.

13. The projection lens according to claim 1, wherein the Fresnel structure is on the light entry side of the substrate.

14. The projection lens according to claim 1, wherein the Fresnel structure is on the light entry emission side of the substrate.

15. A headlamp for a motor vehicle, the headlamp comprising:
at least one light source;
a primary optical element configured to shape a light emitted from the at least one light source such that an expanded light distribution is generated;
a projection lens configured to convert the expanded light distribution generated by the primary optical element into a light distribution corresponding to an output light distribution of the headlamp;
wherein the projection lens is a projection lens according to claim 1.

16. The projection lens according to claim 5, wherein at least one of the sections has a concave curvature, and at least one of the sections has a convex curvature.

17. The projection lens according to claim 8, wherein the curvature of one of the diffractive surfaces has a shape and/or radius that changes continuously in different annular steps of the Fresnel structure toward the outside.

18. The projection lens according to claim 8, wherein the curvature of one of the diffractive surfaces has a shape and/or radius that does not change continuously in different annular steps of the Fresnel structure toward the outside.
